(19) United States
(12) Patent Application Publication
(10) Pub. No.: US 2010/0018104 A1
(43) Pub. Date: Jan. 28, 2010

(54) FISHING ROD HOLDER

(76) Inventors: Edward K. Pedersen, Manassas, VA (US); Kristian E. Pedersen, Manassas, VA (US)

Correspondence Address: SHERR & VAUGHN, PLLC, 620 HERNDON PARKWAY, SUITE 320, HERNDON, VA, 20170, US

(21) Appl. No.: 12/178,113

(22) Filed: Jul. 23, 2008

(51) Int. Cl. A01K 97/10

(52) U.S. Cl. 43/21.2; 224/200; 224/675; 224/672; 224/677; 224/250

(57) ABSTRACT

An apparatus for attachment to a waistband of a wearer for supporting a base end portion of an elongated rod such as a fishing pole adjacent to the leg of the wearer. The apparatus includes an elongated strap having a main portion which extends from the waistband down the leg of the wearer, a first end removeably attachable to the waistband, and a second end having a first support pocket which receives and supports the base end of the elongated rod. The first support pocket is suspended adjacent to and directly contacts the inner thigh of the wearer creating a fulcrum when the elongated rod is supported therein. The creation of the fulcrum permits the elongated rod to be held by the wearer in a stable manner while transferring a majority of the load of the elongated rod from the arms and shoulders of the wearer to the wearer's legs.

### BACKGROUND

Fishing, particularly, recreational fishing and sport fishing, require the use of various equipment such as a fishing pole or rod, reel, line, etc. During a fishing operation, it is sometimes necessary for a fisherman to stand in order to perform various tasks such as threading a line, baiting a hook, attaching lures or leaders, reeling in a fish or removing a fish from a hook. Accomplishing such tasks can be difficult or otherwise cumbersome since it involves the use of both hands, making it awkward for the fisherman to maintain a proper grip on the pole and/or to maintain a proper balance to complete the tasks.

There are various designs of holders which permit the holding of a fishing rod to aid the fisherman when attempting to accomplish the aforementioned tasks. Many such designs, however, or disadvantageous since they require complex designs involving many components, thereby resulting in increased manufacturing costs. Moreover, some fishing rod holder are not easily portable since they require the use of heavy materials such as leather, which burden the fisherman with additional weight. Even still, some fishing rod holders designs are not ergonomically sound, i.e., the holder is positioned such that the base of the fishing rod is at or near the waist of the wearer. Such improper placement of the base of the fishing rod at a high position requires an instable gripping position on the fishing rod which, in turn, places undue stress on the arms and shoulders of the fisherman, especially when in a standing position. Accordingly, it is therefore difficult for the fisherman to stand at a proper position while engaged in a fishing operation. It also undesirable since it does not permit the fisherman to gain proper leverage when in the standing position.

### SUMMARY

Embodiments relate to a fishing rod holder that may include an elongated strap composed of a flexible material which extends down the leg of the wearer to stabilize the fishing rod against the leg (e.g., inner thigh) of the wearer. The flexible strap has a first end that may be removeably attached by a loop to a waistband or belt of the wearer and a second, distal end configured for attachment to a portion of the strap to form a first support opening or pocket. The first support pocket may be sized or otherwise configured to receive and support the base-end of the fishing rod. The first support pocket is suspended adjacent to the inner thigh of the wearer and also contacts the inner thigh of the wearer, thereby creating a fulcrum when the base of the fishing rod is held or supported therein. The creation of the fulcrum permits the fishing rod to be held by the wearer in a stable manner while also transferring a majority of the load of the fishing rod from the arms and shoulders to the leg of the wearer.

Embodiments relate to an apparatus for attachment to a waistband of a wearer to support a base end portion of a fishing rod adjacent the leg of the wearer, the apparatus including at least the following: an elongated strap extending down the leg of a wearer, the strap having a first end forming a loop for removeable attachment to the waistband or belt of the wearer, a second end distal from the first end which forms a first support pocket for receiving and support the base end of the fishing pole. In accordance with embodiments, when the base end of the fishing pole is supported in the first support pocket, it supported against the inner thigh of the wearer to create fulcrum that makes it easier to perform a reeling operation.

Embodiments relate to an apparatus for attachment to a waistband of a wearer to support a base end portion of an elongated rod, the apparatus including at least the following: an elongated strap having a main portion extending from the waistband to the leg of the wearer, a first end of the strap being removeably attachable to the waistband and a second end of the strap forming a first support pocket which receives and supports the base end of the elongated rod. In accordance with embodiments, the first support pocket is suspended adjacent to and directly contacts the inner thigh of the wearer creating a fulcrum when the elongated rod is supported therein.

Embodiments relate to fishing rod holder for attachment to a waistband of a wearer and which supports a base end portion of the fishing rod, the fishing rod holder including at least the following: an elongated strap extending from the waistband down the leg of the wearer, the elongated strap being removeably attached at a first end thereof to the waistband and also having a first support opening; a second support opening concentrically received and supported by the first support opening and configured to receive and support the base end of the fishing rod. In accordance with embodiments, the first support pocket is suspended adjacent to and directly contacts the inner thigh of the wearer creating a fulcrum when the elongated rod is supported in the second support pocket.

### DRAWINGS

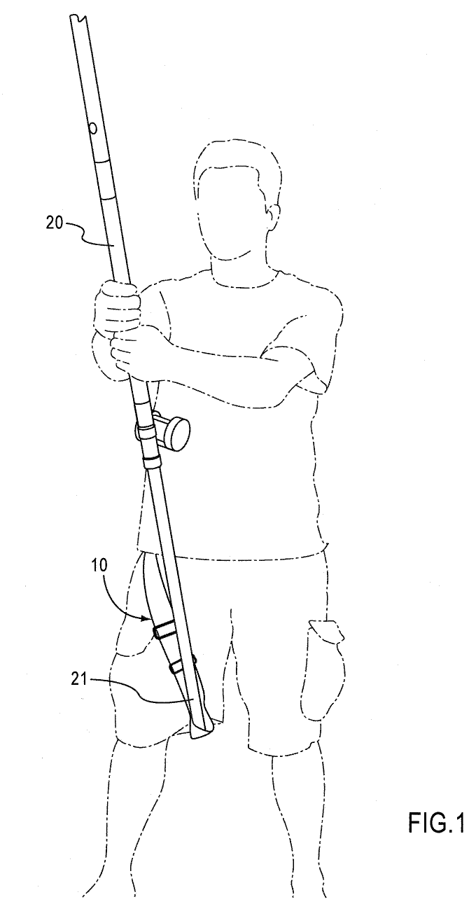

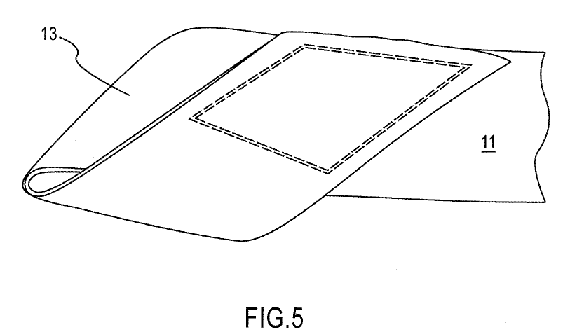

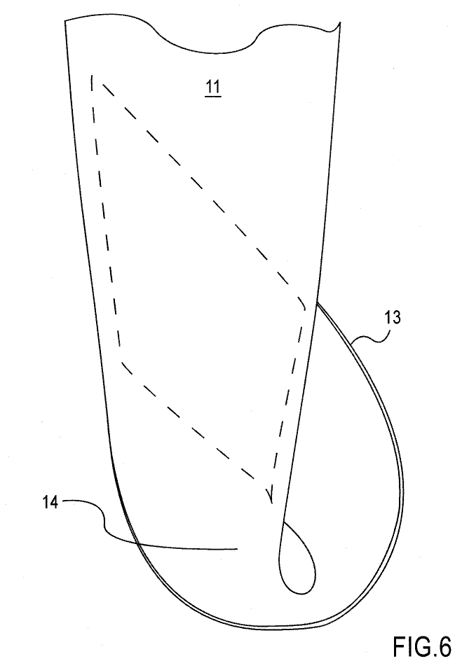

Example FIGS. 1 to 7 illustrate a fishing pole holder in accordance with embodiments.

### DESCRIPTION

Reference will now be made in detail to the preferred embodiments of the present invention, examples of which are illustrated in the accompanying drawings. Wherever possible, the same reference numbers will be used throughout the drawings to refer to the same or like parts. While embodiments illustrated in the example drawing figures illustrate use of the apparatus as a fishing pole holder, embodiments are not limited to such use, and may have application for holding any elongated rod or pole-like object.

As illustrated in example FIGS. 1 to 6, embodiments relate to an apparatus for supporting an elongated rod such as a fishing pole, the apparatus having an ergonomic design which enables the wearer to engage in a fishing operation without placing undue stress on the arms and shoulders while in a standing position. In accordance with embodiments, the apparatus permits a wearer to stand at a proper position while engaged in a fishing operation while also enabling the wearer to gain leverage. Moreover, the apparatus in accordance with embodiments does not have complex designs and uses few working components, thereby decreasing the overall manufacturing costs. The apparatus is composed of a lightweight material that does not burden the wearer.

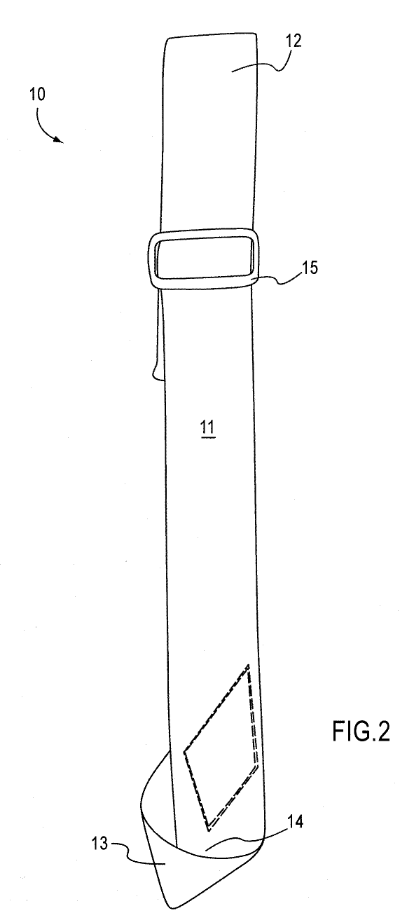

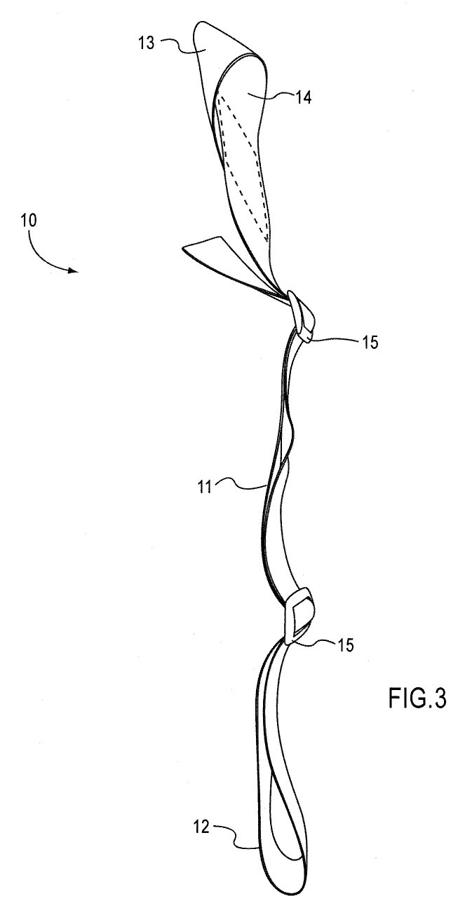

As illustrated in example FIG. 1, fishing rod holder 10 is provided for attachment to a waistband or belt of a wearer to support a base end portion 21 of a fishing pole or rod 20 adjacent to the leg of the wearer. As illustrated in example FIGS. 2 and 3, fishing rod holder 10 may include in accordance with embodiments elongated strap 11 extending down the leg of the wearer. Elongated strap 11 may be composed of one or more flexible, lightweight and robust materials or composite materials. For instance, elongate strap 11 may be composed of a material such as nylon. Use of such lightweight materials permit holder 10 to be easily portable. Holder 10 may also be simply suspended adjacent to the lower thigh of the wearer when not in use without placing any undue tension on the waist of the wearer. Moreover, the use of flexible materials is desirable since holder 10 may be comfortably stored in a pocket of the wearer's shirt, pants or shorts.

As illustrated in example FIG. 3, strap 11 includes first end 12 which forms a loop to facilitate attachment to the belt or waistband of the wearer and second end 13 which is distal to first end 12. The loop at first end 12 may be configured such that it is removeably attached to the waistband or belt. Accordingly, holder 10 may be attached to the waistband simultaneously when the waistband is placed on the pants or shorts of the wearer. Alternatively, holder 10 may be removeably attached to the waistband after the waistband is placed on the pants or shorts of the wearer using a mechanical fastener such as a snap or Velcro® and the like.

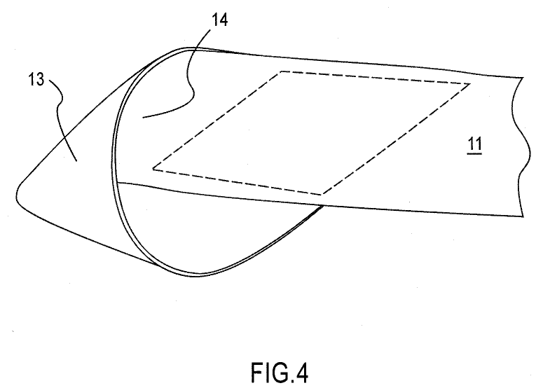

As illustrated in example FIGS. 4 to 6, second end 13 forms first support pocket 14 sized or otherwise configured to receive and support base end 21 of fishing rod 20. First support pocket 14 may be formed by folding over and attaching distal second end 13 to a portion of elongated strap 11 extending between first end 12 and second end 13. Second end 13 may be attached by manual or automated stitching. Accordingly, first support pocket 14 may be selectively sized to accommodate and support base end 21 of various diameters depending upon the placement of the attachment point of second end 13 on strap 11. Alternatively, first support pocket may have a selectively adjustable feature in order to accommodate and support base end 21 of various diameters. Because strap 11, and thus, first support pocket 13, are composed of robust materials such as nylon, rods 20 of various weights and configurations may be comfortably supported by holder 10.

As illustrated in example FIG. 1, first support pocket 13 is suspended adjacent the thigh of the wearer, and when base end 21 of fishing rod 20 is supported therein, contacts or otherwise abuts the inner thigh of the wearer to create a fulcrum. Such a creation of a fulcrum permits the wearer to stably hold fishing rod 20 without use of both hands. The fulcrum is also advantageous since it also permits, during a fishing operation, the wearer to stand erect and use the pivot point created at the inner thigh when reeling in a fish. Rod 10 may also include at least one tension lock 15 for placement on elongated strap 11 to facilitate selective adjustments to be made to the length of the elongated strap 11. Such selective adjustments are useful in permitting holder 10 to accommodate wearers of varying heights.

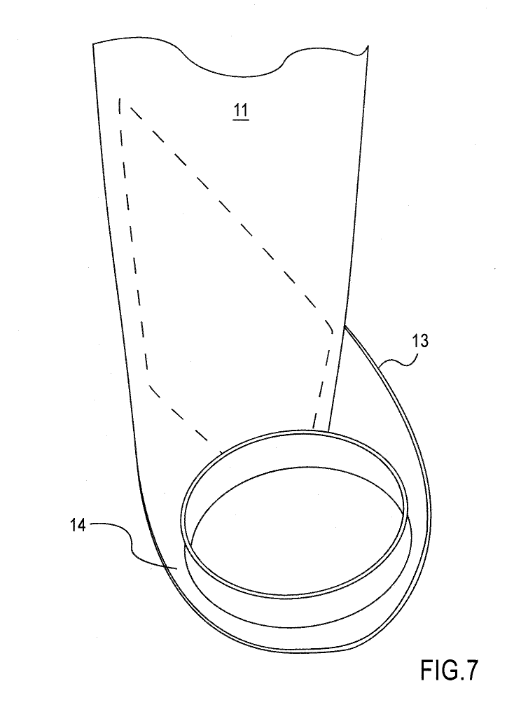

As illustrated in example FIG. 7, fishing rod holder 10 may also include second support pocket 16 concentrically received and supported by first support pocket 14. Second support pocket may serve to receive and support base end 21 of fishing pole 20. Second support pocket 16 may be composed of flexible, lightweight and robust materials or composite materials. For instance, second support pocket 16 may be composed of a polymer-based material. Second support pocket 16 may be removeably and concentrically received and supported by first support pocket 14. Second support opening 16 may be configured to have a plurality of concentric, telescopic support platforms of various diameters to receive base end 21 of various sizes.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus for attachment to a waistband of a wearer to support a base end portion of a fishing rod adjacent the leg of the wearer, the apparatus comprising:
an elongated strap extending down the leg of a wearer, the elongated strap having a first end forming a loop for attachment to the belt of the wearer and a second end distal to the first end and which forms a first support pocket for receiving and supporting the base end of the fishing pole, wherein the first support pocket is suspended against the inner thigh of the wearer creating fulcrum when the base end of the fishing pole is supported therein.

2. The apparatus of claim 1, further comprising a second support pocket concentrically received by the first support pocket for receiving and supporting the base-end of the fishing pole.

3. The apparatus of claim 1, wherein the second support pocket is removeably and concentrically received by the first support pocket.

4. The apparatus of claim 3, wherein the second support pocket is composed of a flexible, lightweight material.

5. The apparatus of claim 4, wherein said flexible, lightweight material comprises a polymer-based material.

6. The apparatus of claim 1, wherein the first support pocket is formed by attaching the distal end of the elongated strap to the elongated strap.

7. The apparatus of claim 1, wherein the elongated strap is composed of a flexible, lightweight material.

8. The apparatus of claim 7, wherein said flexible, lightweight material comprises nylon.

9. The apparatus of claim 1, further comprising at least one tension lock for placement on the elongated strap to permit selective adjustments to the length of the elongated strap to accommodate wearers of varying heights.

10. The apparatus of claim 1, wherein the loop is removeably attached to the waistband of the wearer.

11. An apparatus for attachment to a waistband of a wearer for supporting a base end portion of an elongated rod adjacent to the leg of the wearer, the apparatus comprising:
an elongated strap having a main portion extending from the waistband to the leg of the wearer, the elongated strap having a first end removeably attachable to the waistband and a second end forming a first support pocket which receives and supports the base end of the elongated rod, wherein the first support pocket is suspended adjacent to and directly contacts the inner thigh of the wearer creating a fulcrum with the leg of the wearer when the elongated rod is supported therein.

12. The apparatus of claim 11, wherein the elongated strap is composed of a polymer-based material.

13. The apparatus of claim 11, further comprising at least one tension lock for selective adjusting the length of the elongated strap to accommodate wearers of varying heights.

14. A fishing rod holder for attachment to a waistband of a wearer, the fishing rod holder comprising:
an elongated strap extending from the waistband down the leg of the wearer, the elongated strap being removeably attached at a first end thereof to the waistband and also having a first support opening formed distal to the first end;
a second support opening concentrically received and supported by the first support opening for receiving and supporting the base end of the fishing pole elongated item,
wherein the first support pocket is suspended adjacent to and directly contacts the inner thigh of the wearer creating a fulcrum when the fishing rod is supported in the second support pocket.

15. The fishing rod holder of claim 14, wherein the elongated strap is composed of a nylon-based material.

16. The fishing rod holder of claim 14, further comprising at least one tension lock for selective adjusting the length of the elongated strap to accommodate wearers of varying heights.

17. The fishing rod holder of claim 14, wherein the second support opening is composed of a polymer-based material.

18. The fishing rod holder of claim 14, wherein the second support opening is rigidly attached to the first support opening.

19. The fishing rod holder of claim 14, wherein the second support opening is removeably attached to the first support opening.

20. The fishing rod holder of claim 14, wherein the second support opening has a plurality of concentric, telescopic support platforms of various diameters which permit the fishing rod holder to receive the base end of fishing rods of various sizes.
